(19) United States
(12) Patent Application Publication
(10) Pub. No.: US 2024/0250269 A1
(43) Pub. Date: Jul. 25, 2024

(54) ALL-SOLID-STATE BATTERY INCLUDING A POROUS COMPOSITE MEMBRANE

(71) Applicants: Hyundai Motor Company, Seoul (KR); Kia Corporation, Seoul (KR)

(72) Inventors: Hong Suk Choi, Hwaseong (KR); Sang Wan Kim, Anyang (KR); Hee Soo Kang, Seoul (KR); Jae Min Lim, Suwon (KR); Seon Hwa Kim, Cheongju (KR)

(21) Appl. No.: 18/237,287

(22) Filed: Aug. 23, 2023

(30) Foreign Application Priority Data
Jan. 20, 2023 (KR) 10-2023-0008640

(51) Int. Cl. H01M 4/66; H01M 4/80

(52) U.S. Cl. CPC H01M 4/667; H01M 4/661; H01M 4/663; H01M 4/80; H01M 2220/20

(57) ABSTRACT

Disclosed is an anodeless all-solid-state battery including a porous composite membrane in place of an anode current collector.

### CROSS-REFERENCE TO RELATED APPLICATION

This application claims under 35 U.S.C. § 119(a) the benefit of priority to Korean Patent Application No. 10-2023-0008640 filed on Jan. 20, 2023, the entire contents of which are incorporated herein by reference.

### TECHNICAL FIELD

The present disclosure relates to an anodeless all-solid-state battery including a porous composite membrane in place of an anode current collector.

### BACKGROUND

An all-solid-state battery includes solid electrolytes in place of a liquid electrolyte and separators of a lithium ion battery. When the lithium ion battery is charged and discharged at a high speed, heat is generated, and the lithium ion battery includes a flammable carbonate-based organic solvent as a component of the liquid electrolyte and thus has a problem of stability. The separators are provided to prevent explosion and fire in the lithium ion battery, but the separators lower the energy density of the lithium ion battery per unit volume. The all-solid-state battery is a next-generation battery which may prevent a decrease in energy density per unit volume while solving low thermal stability caused by the liquid electrolyte.

In an all-solid-state battery field, many attempts have been made to increase a capacity per unit volume and energy density per unit volume. For example, an anodeless all-solid-state battery which stores lithium ions by plating a current collector with lithium not through reaction between lithium ions and an active material, or an all-solid-state battery which excludes a current collector so as to reduce the volume of the battery, were developed.

However, the anodeless all-solid-state battery exhibits a low energy density contrary to expectations, because lithium is non-uniformly deposited on the current collector. Further, the amount of lithium non-uniformly deposited on the current collector is increased and thus causes thickness variations as the charge cycle of the anodeless all-solid-state battery progresses, and thereby, the anodeless all-solid-state battery has limitation, i.e., a low capacity, a short lifespan, etc.

The above information disclosed in this Background section is only for enhancement of understanding of the background of the invention and therefore it may contain information that does not form the prior art that is already known in this country to a person of ordinary skill in the art.

### SUMMARY

In preferred aspects, the present disclosure provides an anodeless all-solid-state battery having an excellent capacity retention rate.

A term “all-solid-state battery” as used herein refers to a rechargeable secondary battery that includes an electrolyte in a solid state for transferring ions between the electrodes of the battery.

The term “anodeless-type all-solid-state battery” as used herein refers to an all-solid state battery that lacks a compatible, parallel and/or structural similar looking component of the counter electrode of a cathode, i.e. anode. Rather the anodeless-type all-solid battery may include a functional component that similarly or equivalently serves as a conventional anode. In certain embodiments, the anode current collector layer may be used as the counter electrode of the cathode in the anodeless-type all-solid battery without including an anode layer (e.g., lacking anode active material layer or lithium layer) and form non-matching or non-symmetric structure to the cathode.

Also provided is an anodeless all-solid-state battery having a high energy density.

Further provided is an anodeless all-solid-state battery having a long lifespan.

In one aspect, the present disclosure provides an all-solid-state battery including a composite membrane including a first surface and a second surface, a first solid electrolyte layer disposed on the first surface of the composite membrane, a first cathode active material layer disposed on the first solid electrolyte layer, a first cathode current collector disposed on the first cathode active material layer, a second solid electrolyte layer disposed on the second surface of the composite membrane, a second cathode active material layer disposed on the second solid electrolyte layer, and a second cathode current collector disposed on the second cathode active material layer.

In particular, the composite membrane may include a conductive material, the composite membrane may include pores, the composite membrane may include a first layer configured to form the first main surface, a second layer configured to form the second surface, and an intermediate layer located between the first layer and the second layer, and the first layer and the second layer may include metal powder configured to be alloyable with lithium.

The “composite membrane” may include plurality of shapes of pores (e.g., spherical, or non-spherical), holes, cavity (e.g., microcavity), labyrinth, channel or the like, whether formed uniformly or without regularity. Exemplary composite membrane may include pores (e.g., closed or open pores) within a predetermined size within a range from sub-micrometer (nanometer) to micrometer size, which is measured by maximum diameter of the pores.

The conductive material may include a linear carbon material.

The linear carbon material may include carbon nanofibers, carbon nanotubes, vapor-grown carbon fibers, and combinations thereof.

Preferably, a length of the linear carbon material may be about 0.01 μm to 1 μm.

Preferably, a diameter of the linear carbon material may be about 1 nm to 200 nm.

The linear carbon material may form a net shape so that the composite membrane comprises pores, and lithium may be stored in the pores when the all-solid-state battery is charged.

Preferably, a porosity of the composite membrane may be about 0.1% to 50%.

A thickness of the composite membrane may be about 1 μm to 200 μm.

Preferably, a thickness of the first layer may be about 10% to 40% of an overall thickness of the composite membrane, a thickness of the second layer may be about 10% to 40% of the overall thickness of the composite membrane, and a thickness of the intermediate layer may be about 20% to 80% of the overall thickness of the composite membrane.

The metal powder may include at least one selected from the group consisting of aluminum (Al), zinc (Zn), indium (In), silver (Ag), gold (Au), magnesium (Mg), silicon (Si), bismuth (Bi), germanium (Ge), platinum (Pt), antimony (Sb), and tin (Sn).

A median particle diameter D50 of the metal powder may be about 0.01 μm to 1 μm.

The first layer may include an amount of about 50 wt % to 99 wt % of the porous conductive material, an amount of about 0.1 wt % to 45 wt % of the metal powder, and an amount of about 0.1 wt % to 10 wt % of a binder, based on the total weight of the first layer.

The second layer may include an amount of about 50 wt % to 99 wt % of the porous conductive material, an amount of about 0.1 wt % to 45 wt % of the metal powder, and an amount of about 0.1 wt % to 10 wt % of a binder based on the total weight of the second layer.

The intermediate layer may include an amount of about 90 wt % to 99.9 wt % of the porous conductive material, and an amount of about 0.1 wt % to 10 wt % of a binder, based on the total weight of the intermediate layer.

Also provided is a vehicle including the all-solid-state batter as described herein.

Other aspects of the invention are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 shows an exemplary embodiment of an all-solid-state battery according to an exemplary embodiment of the present disclosure;

FIG. 2 shows an exemplary embodiment of an all-solid-state battery according to an exemplary embodiment of the present disclosure;

FIG. 3 shows an exemplary composite membrane according to an exemplary embodiment of the present disclosure;

FIG. 4 shows result of scanning electron microscopy (SEM) analysis of the longitudinal section of the composite membrane according to an exemplary embodiment of the present disclosure;

FIG. 5 shows the capacity retention rates of all-solid-state batteries according to Example, Comparative Example 1, and Comparative Example 2;

FIG. 6 shows the result of cross section polisher scanning electron microscopy (CP-SEM) analysis of the longitudinal section of the all-solid-state battery according to Example in the first charged state;

FIG. 7A shows the result of computed tomography (CT) analysis of the surface of a first cathode active material layer of the all-solid-state battery according to Example;

FIG. 7B shows the result of computed tomography (CT) analysis of the surface of a composite membrane of the all-solid-state battery according to Example;

FIG. 7C shows the result of computed tomography (CT) analysis of the surface of a second cathode active material layer of the all-solid-state battery according to Example;

FIG. 8A shows the result of computed tomography (CT) analysis of the surface of a first cathode active material layer of the all-solid-state battery according to Comparative Example 2;

FIG. 8B shows the result of computed tomography (CT) analysis of the surface of a composite membrane of the all-solid-state battery according to Comparative Example 2; and

FIG. 8C shows the result of computed tomography (CT) analysis of the surface of a second cathode active material layer of the all-solid-state battery according to Comparative Example 2.

It should be understood that the appended drawings are not necessarily to scale, presenting a somewhat simplified representation of various preferred features illustrative of the basic principles of the invention. The specific design features of the present disclosure as disclosed herein, including, for example, specific dimensions, orientations, locations, and shapes, will be determined in part by the particular intended application and use environment.

In the figures, reference numbers refer to the same or equivalent parts of the present disclosure throughout the several figures of the drawing.

### DETAILED DESCRIPTION

The above-described objects, other objects, advantages and features of the present disclosure will become apparent from the descriptions of embodiments given hereinbelow with reference to the accompanying drawings. However, the present disclosure is not limited to the embodiments disclosed herein and may be implemented in various different forms. The embodiments are provided to make the description of the present disclosure thorough and to fully convey the scope of the present disclosure to those skilled in the art.

In the following description of the embodiments, the same elements are denoted by the same reference numerals even when they are depicted in different drawings. In the drawings, the dimensions of structures may be exaggerated compared to the actual dimensions thereof, for clarity of description. In the following description of the embodiments, terms, such as “first” and “second”, may be used to describe various elements but do not limit the elements. These terms are used only to distinguish one element from other elements. For example, a first element may be named a second element, and similarly, a second element may be named a first element, without departing from the scope and spirit of the invention. Singular expressions may encompass plural expressions, unless they have clearly different contextual meanings.

In the following description of the embodiments, terms, such as “including”, “comprising” and “having”, are to be interpreted as indicating the presence of characteristics, numbers, steps, operations, elements or parts stated in the description or combinations thereof, and do not exclude the presence of one or more other characteristics, numbers, steps, operations, elements, parts or combinations thereof, or possibility of adding the same. In addition, it will be understood that, when a part, such as a layer, a film, a region or a plate, is said to be “on” another part, the part may be located “directly on” the other part or other parts may be interposed between the two parts. In the same manner, it will be understood that, when a part, such as a layer, a film, a region or a plate, is said to be “under” another part, the part may be located “directly under” the other part or other parts may be interposed between the two parts.

All numbers, values and/or expressions representing amounts of components, reaction conditions, polymer compositions and blends used in the description are approximations in which various uncertainties in measurement generated when these values are acquired from essentially different things are reflected and thus it will be understood that they are modified by the term “about”, unless stated otherwise. Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

In addition, it will be understood that, if a numerical range is disclosed in the description, such a range includes all continuous values from a minimum value to a maximum value of the range, unless stated otherwise. Further, if such a range refers to integers, the range includes all integers from a minimum integer to a maximum integer, unless stated otherwise. In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

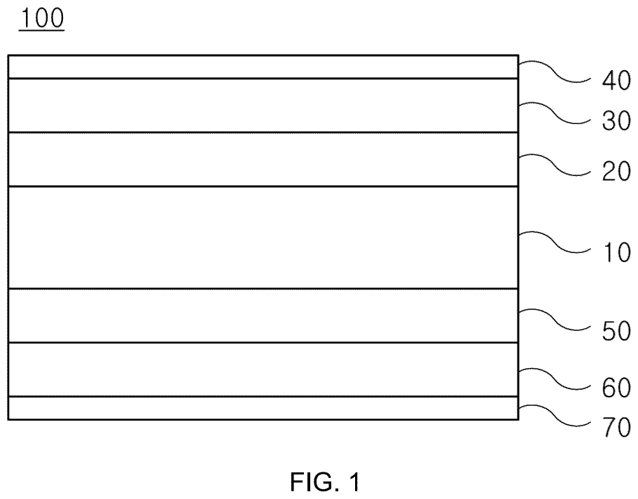

FIG. 1 shows an embodiment all-solid-state battery according to an exemplary embodiment of the present disclosure. The all-solid-state battery 100 may include a composite membrane 10, a first solid electrolyte layer 20 disposed on one surface of the composite membrane 10, a first cathode active material layer 30 disposed on the first solid electrolyte layer 20, a first cathode current collector 40 disposed on the first cathode active material layer 30, a second solid electrolyte layer 50 disposed on the other surface of the composite membrane 10, a second cathode active material layer 60 disposed on the second solid electrolyte layer 50, and a second cathode current collector 70 disposed on the second cathode active material layer 60.

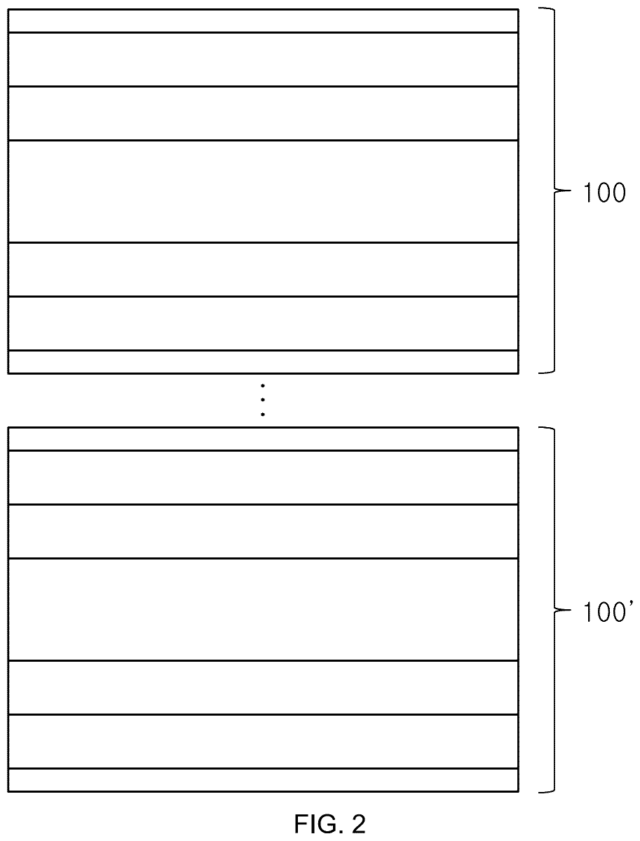

FIG. 2 shows an exemplary embodiment of an all-solid-state battery according to an exemplary embodiment of the present disclosure. Particularly, a plurality of all-solid-state batteries 100 and 100′ may be stacked. The number of stacked all-solid-state batteries is not limited to a specific value, and may be properly adjusted depending on a desired capacity, energy density, etc.

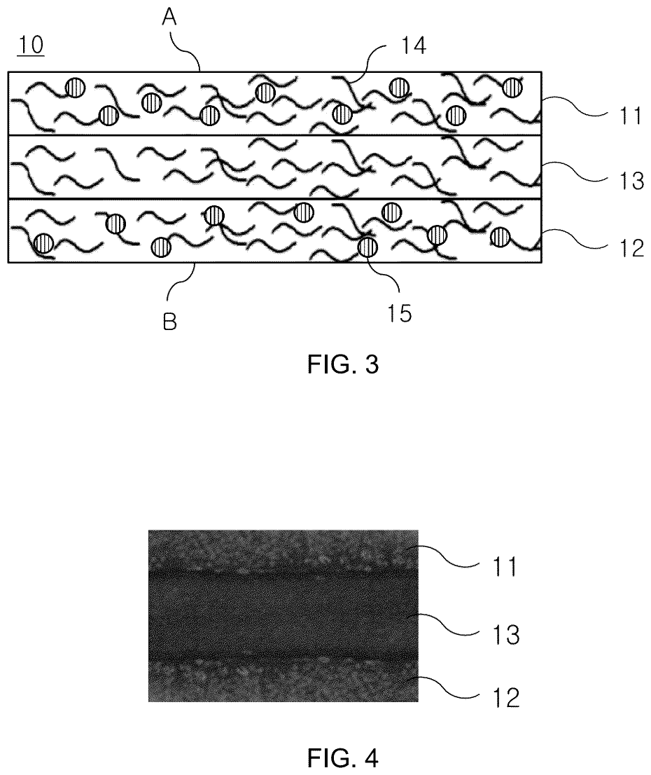

FIG. 3 shows an exemplary composite membrane 10 according to an exemplary embodiment of the present disclosure. The composite membrane 10 may be a sheet type including a first surface A and a second surface B opposite to the first surface A.

The composite membrane 10 is an element used as a substitute for the anode current collector of a conventional lithium secondary battery, and may include a conductive material 14 configured to transport electrons therein.

The conductive material 14 may include a linear carbon material.

The linear carbon material may include carbon nanofibers, carbon nanotubes, vapor-grown carbon fibers, and combinations thereof.

The length of the linear carbon material may be about 0.01 μm to 1 μm. The diameter of the linear carbon material may be about 1 nm to 200 nm. When the length of the linear carbon material exceeds 1 m or the diameter of the linear carbon material is greater than about 200 nm, the thickness of the composite membrane 10 may be excessively increased.

In the linear carbon material of the composite membrane 10, at least a part of one carbon structure may come into contact with other carbon structures adjacent thereto so as to form a net shape. The net shape may collectively refer to shapes formed through random combinations of the carbon structures in the linear carbon material. Since the linear carbon material form the net shape, the composite membrane 10 may be porous, and may thus include pores. The pores may indicate remaining spaces in which no linear carbon materials are located.

When the all-solid-state battery 100 is charged, lithium ions (Li) emitted by the first cathode active material layer 30 may reach the composite membrane 10 through the first solid electrolyte layer 20, may react with electrons in the composite membrane 10, and may be deposited and stored in the form of lithium metal in the pores. Further, when the all-solid-state battery 100 is charged, lithium ions (Li) emitted by the second cathode active material layer 60 may reach the composite membrane 10 through the second solid electrolyte layer 50, may react with electrons in the composite membrane 10, and may be deposited and stored in the form of lithium metal in the pores.

The pores may be open pores. The open pores may form a structure in which the pores are interconnected. The open pores are interconnected, and may thus provide a passage which lithium ions (Li) may permeate in a three-dimensional structure. Therefore, the composite membrane 10 receives lithium ions (Li) bidirectionally, i.e., through the first surface A and the second surface B, and may thus store lithium ions (Li) not only on the main surfaces A and B of the composite membrane 10 but also in the composite membrane 10.

The porosity of the composite membrane 10 may be about 0.1% to 50%. The porosity is a fraction of the volume of pores included in a unit volume, and may be calculated by Equation of (true density of material−thin film density)/true density×100. The true density of a material may be measured by a gas replacement method (i.e., the pycnometer method) or a liquid state reaction method (i.e., Archimedes' method). A thin film density may be calculated as Equation of weight of thin film/(thickness of thin film×area of thin film). When the porosity of the composite membrane 10 is greater than about 50%, the mechanical properties of the composite membrane 10 are lowered, and thus, the structure of the composite membrane 10 may collapse when lithium metal is stored in the pores.

The thickness of the composite membrane 10 may be about 1 μm to 200 μm. When the thickness of the composite membrane 10 is less than about 1 μm, the composite membrane 10 may have difficulty in maintaining the shape thereof. When the thickness of the composite membrane 10 is greater than about 200 μm, an amount of lithium ions (Li+) deposited and stored in the form of lithium metal, when the all-solid-state battery 100 is charged, may be reduced and thus energy density may be reduced.

The composite membrane 10 may include a first layer 11 configured to form the first surface A, a second layer 12 configured to form the second surface B, and an intermediate layer 13 provided between the first layer 11 and the second layer 12. The formation of the first surface A may mean that the surface of the first layer 11 becomes the first surface A. The formation of the second surface B may mean that the surface of the second layer 12 becomes the second surface B.

The first layer 11 and the second layer 12 may include metal powder 15 which may form an alloy with lithium.

The metal powder 15 may serve as a kind of seed, and may assist in nucleation and growth of lithium metal in the composite membrane 10.

The metal powder 15 may include one or more selected from the group consisting of aluminum (Al), zinc (Zn), indium (In), silver (Ag), gold (Au), magnesium (Mg), silicon (Si), bismuth (Bi), germanium (Ge), platinum (Pt), antimony (Sb), and tin (Sn).

The median particle diameter D50 of the metal powder 15 may be about 0.01 μm to 1 μm. The median particle diameter D50 may be measured using a commercially available laser diffraction scattering particle size analyzer. When the median particle diameter D50 of the metal powder 15 is greater than about 1 μm, the composite membrane 10 may become thicker, and the porosity of the composite membrane 10 may be reduced.

The thickness of the first layer 11 may be about 10% to 40% of the overall thickness of the composite membrane 10.

The thickness of the second layer 12 may be about 10% to 40% of the overall thickness of the composite membrane 10. The thickness of the second layer 12 may be the same as or different from the thickness of the first layer 11.

The thickness of the intermediate layer 13 may be about 20% to 80% of the overall thickness of the composite membrane 10.

The first layer 11 may include an amount of about 50 wt % to 99 wt % of the porous conductive material 14, an amount of about 0.1 wt % to 45 wt % of the metal powder 15, and an amount of about 0.1 wt % to 10 wt % of a binder, based on the total weight of the first layer 11. When the content of the metal powder 15 is greater than about 45 wt %, the energy density of the all-solid-state battery 100 may be reduced.

The second layer 12 may include an amount of about 50 wt % to 99 wt % of the porous conductive material 14, an amount of about 0.1 wt % to 45 wt % of the metal powder 15, and an amount of about 0.1 wt % to 10 wt % of a binder based on the total weight of the second layer 12. When the content of the metal powder 15 is greater than about 45 wt %, the energy density of the all-solid-state battery 100 may be reduced.

The intermediate layer 13 may include an amount of about 90 wt % to 99.9 wt % of the porous conductive material 14, and an amount of about 0.1 wt % to 10 wt % of a binder, based on the total weight of the intermediate layer 13.

Each of the binder of the first layer 11, the binder of the second layer 12, and the binder of the intermediate layer 13 may include one or more selected from the group consisting of nitrile butadiene rubber (NBR), hydrogenated nitrile butadiene rubber (HNBR), styrene butadiene rubber (SBR), butadiene rubber (BR), polyvinylidene fluoride (PVDF), polytetrafluoroethylene (PTFE), polyacrylic acid (PAA), carboxymethyl cellulose (CMC), and alginic acid.

Each of the first solid electrolyte layer 20 and the second solid electrolyte layer 50 may include a solid electrolyte having lithium ion conductivity.

The solid electrolyte may include an oxide-based solid electrolyte, a sulfide-based solid electrolyte, or a polymer electrolyte.

The oxide-based solid electrolyte may include perovskite-type LLTO (Li₃ₓLa_{2/3-x}TiO₃), phosphate-based NASICON-type LATP (Li₁₋ₓAlₓTi₂₋ₓ(PO₄)₃), or the like.

The sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n being positive numbers, and Z being one of Ge, Zn and Ga), Li₂S—GeS₂, Li₂S—SiS₂—Li₃PO₄, Li₂S—SiS₂—LiₓMO_{y} (x and y being positive numbers, and M being one of P, Si, Ge, B, Al, Ga and In), Li₁₀GeP₂S₁₂, or the like.

The polymer electrolyte may include a gel polymer electrolyte, a solid polymer electrolyte, or the like.

Each of the first cathode active material layer 30 and the second cathode active material layer 60 may include a cathode active material, a solid electrolyte, a binder, a cathode conductive material, etc.

The cathode active material may include a rock salt layer-type active material, such as LiCoO₂, LiMnO₂, LiNiO₂, LiVO₂ or Li₁₋ₓNi_{1/3}Co_{1/3}Mn_{1/3}O₂, a spinel-type active material, such as LiMn₂O₄ or Li(Ni_{0.5}Mn_{1.5})O₄, an inverted spinel-type active material, such as LiNiVO₄ or LiCoVO₄, an olivine-type active material, such as LiFePO₄, LiMnPO₄, LiCoPO₄ or LiNiPO₄, a silicon-containing active material, such as Li₂FeSiO₄ or Li₂MnSiO₄, a rock salt layer-type active material in which a part of a transition metal is substituted with a different kind of metal, such as LiNi_{0.8}Co_{(0.2-x)}AlₓO₂ (0<x<0.2), a spinel-type active material in which a part of a transition metal is substituted with a different kind of metal, such as Li₁₋ₓMn_{2-x-y}M_{y}O₄ (M being at least one of Al, Mg, Co, Fe, Ni or Zn, and 0<x+y<2), or lithium titanate, such as Li₄Ti₅O₁₂.

The solid electrolyte may include an oxide-based solid electrolyte, a sulfide-based solid electrolyte, or a polymer electrolyte. The detailed kinds of the respective electrolytes were described above.

The binder may include at least one selected from the group consisting of nitrile butadiene rubber (NBR), hydrogenated nitrile butadiene rubber (HNBR), styrene butadiene rubber (SBR), butadiene rubber (BR), polyvinylidene fluoride (PVDF), polytetrafluoroethylene (PTFE), polyacrylic acid (PAA), carboxymethyl cellulose (CMC), alginic acid, and combinations thereof. The binders of the first cathode active material layer 30 and the second cathode active material layer 60 may be the same as or different from the binder of the composite membrane 10.

The cathode conductive material may include carbon black, conductive graphite, ethylene black, graphene, or the like.

The contents of the cathode active materials, the solid electrolytes, the binders, the cathode conductive materials, etc. of the first cathode active material layer 30 and the second cathode active material layer 60 are not limited to specific values, and may be properly adjusted in consideration of the desired capacity, efficiency, etc. of the all-solid-state battery 100.

Each of the first cathode current collector 40 and the second cathode current collector 70 may be a plate-shaped base material having electrical conductivity. Each of the first cathode current collector 40 and the second cathode current collector 70 may include aluminum (Al), copper (Cu), nickel (Ni), cobalt (Co), iron (Fe), zinc (Zn), or the like.

### EXAMPLE

Hereinafter, the present disclosure will be described in more detail through the following examples. The following examples serve merely to exemplarily describe the present disclosure, and are not intended to limit the scope of the invention.

### Example

Carbon nanotubes having a length of about 1 μm and a diameter of about 50 nm were prepared as the linear carbon material.

A first slurry was prepared by putting the carbon nanotubes and polyvinylidene fluoride (PVDF) together with zirconia balls into N-methyl-2-pyrrolidone (NMP), and performing ball milling using a Thinky mixer at about 2,000 rpm for about 5 minutes.

A second slurry was prepared by putting the carbon nanotubes, polyvinylidene fluoride (PVDF), and silver (Ag) powder together with zirconia balls into N-methyl-2-pyrrolidone (NMP), and performing ball milling using a Thinky mixer at about 2,000 rpm for about 5 minutes. The median particle diameter D50 of the silver (Ag) powder was about 0.5 μm.

A self-supporting film was prepared using the first slurry by a vacuum filtering apparatus. An intermediate layer was acquired by completely removing a solvent remaining in the self-supporting film through vacuum drying. A first layer was formed by applying the second slurry to one surface of the intermediate layer and then performing vacuum drying. A second layer was formed by applying the second slurry to the other surface of the intermediate layer and then performing vacuum drying. The thickness of the intermediate layer was about 150 μm, and the thicknesses of the first layer and the second layer were about 25 μm. Thereby, a composite membrane was manufactured.

FIG. 4 shows the result of scanning electron microscopy (SEM) analysis of the longitudinal section of the above-manufactured composite membrane. Parts which look bright in the first layer 11 and the second layer 12 indicate the silver (Ag) powder.

A first solid electrolyte layer and a second solid electrolyte layer, each of which includes a sulfide-based solid electrolyte, were adhered to both surfaces of the composite membrane. A first cathode active material layer including lithium nickel cobalt manganese oxide was formed on the first solid electrolyte layer, and a second cathode active material layer including the same lithium nickel cobalt manganese oxide was formed on the second solid electrolyte layer. Aluminum foil serving as a cathode current collector was adhered to each of the first cathode active material layer and the second cathode active material layer. An all-solid-state battery was manufactured by isostatically pressing a stack, acquired by the above-described method, at a pressure of about 450 MPa.

### Comparative Example 1

A general anodeless battery was manufactured. A slurry was prepared by putting Super C65, polyvinylidene fluoride (PVDF), and silver (Ag) powder together with zirconia balls into N-methyl-2-pyrrolidone (NMP), and performing ball milling using a Thinky mixer at about 2,000 rpm for about 5 minutes.

A coating layer was formed by applying the slurry to nickel foil serving as an anode current collector to a thickness of about 10 μm and then drying the slurry.

The solid electrolyte layer, the cathode active material layer and the cathode current collector, which are the same as those in Example, were adhered to the coating layer. An all-solid-state battery was manufactured by isostatically pressing a stack, acquired by the above-described method, at a pressure of about 450 MPa.

### Comparative Example 2

A first coating layer was formed by applying the slurry according to Comparative Example 1 to one surface of nickel foil serving as an anode current collector to a thickness of about 10 μm and then drying the slurry. A second coating layer was formed by applying the slurry according to Comparative Example 1 to the other surface of the nickel foil to a thickness of about 10 μm and then drying the slurry. Hereinafter, a structure acquired by stacking the first coating layer and the second coating layer on both surfaces of the nickel foil will be referred to as a composite membrane according to Comparative Example 2.

A first solid electrolyte layer and a second solid electrolyte layer, each of which includes a sulfide-based solid electrolyte, were adhered to the surfaces of the first coating layer and the second coating layer, in the same manner as in Example. A first cathode active material layer including lithium nickel cobalt manganese oxide was formed on the first solid electrolyte layer, and the second cathode active material layer including the same lithium nickel cobalt manganese oxide was formed on the second solid electrolyte layer. Aluminum foil serving as a cathode current collector was adhered to each of the first cathode active material layer and the second cathode active material layer. An all-solid-state battery was manufactured by isostatically pressing a stack, acquired by the above-described method, at a pressure of about 450 MPa.

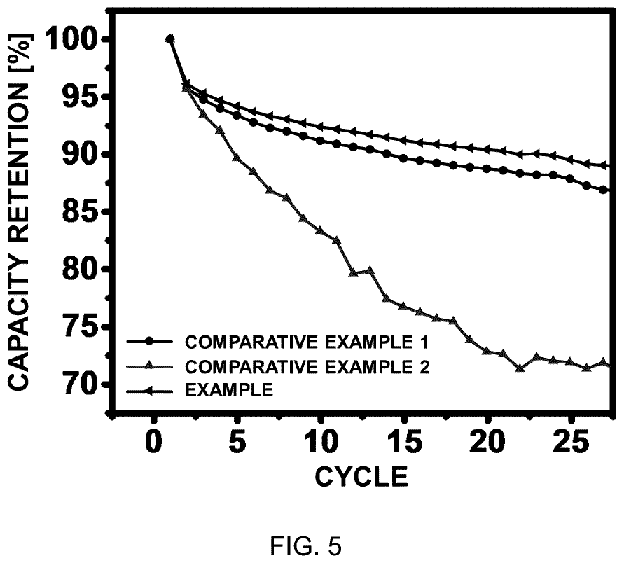

The capacity retention rates of the all-solid-state batteries according to Example, Comparative Example 1, and Comparative Example 2 were measured while charging and discharging the all-solid-state-batteries under conditions of 0.33 C, 2.5 V-4.25 V, and 50° C. during operation of the all-solid-state batteries at a pressure of about 100 MPa. The results are shown in FIG. 5. The capacity retention rate of the all-solid-state battery according to Example was equal to or greater than 90% even in the 25^{th} charge cycle or more, and, on the other hand, the capacity retention rate of the all-solid-state battery having a bi-cell structure according to Comparative Example 2 was rapidly reduced.

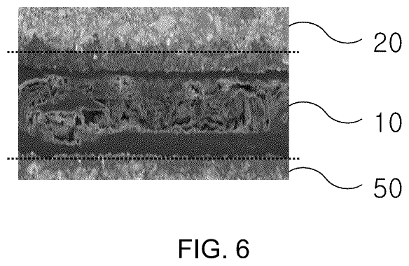

FIG. 6 shows the result of cross section polisher scanning electron microscopy (CP-SEM) analysis of the longitudinal section of the all-solid-state battery according to Example in the first charged state. It may be confirmed that lithium was stored in the composite membrane 10 and the first solid electrolyte layer 20 and the second solid electrolyte layer 50 were not fractured.

The all-solid-state batteries according to Example and Comparative Example 2 in the first charged state were disassembled, and thereafter, the surfaces of the composite membranes, the first cathode active material layers and the second cathode active material layers of the respective all-solid-state batteries were analyzed through computed tomography (CT).

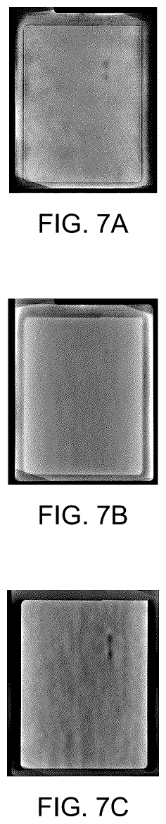

FIG. 7A shows the result of computed tomography (CT) analysis of the surface of the first cathode active material layer of the all-solid-state battery according to Example. FIG. 7B shows the result of computed tomography (CT) analysis of the surface of the composite membrane of the all-solid-state battery according to Example. FIG. 7C shows the result of computed tomography (CT) analysis of the surface of the second cathode active material layer of the all-solid-state battery according to Example.

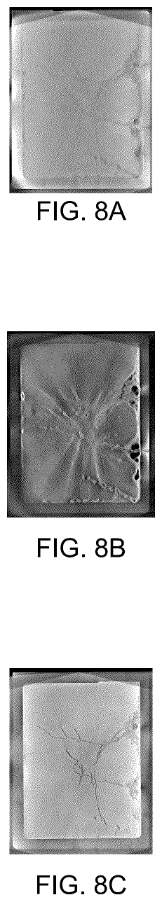

FIG. 8A shows the result of computed tomography (CT) analysis of the surface of the first cathode active material layer of the all-solid-state battery according to Comparative Example 2. FIG. 8B shows the result of computed tomography (CT) analysis of the surface of the composite membrane of the all-solid-state battery according to Comparative Example 2. FIG. 8C shows the result of computed tomography (CT) analysis of the surface of the second cathode active material layer of the all-solid-state battery according to Comparative Example 2.

Referring to FIGS. 8A to 8C, the composite membrane of the all-solid-state battery according to Comparative Example 2 was fractured, and lithium dendrites were asymmetrically formed on the first cathode active material layer and the second cathode active material layer of the all-solid-state battery according to Comparative Example 2. On the other hand, referring to FIGS. 7A to 7C, cracks caused by lithium dendrites did not occur in the all-solid-state battery according to Example 1.

As is apparent from the above description, the present disclosure may provide an anodeless all-solid-state battery having an excellent capacity retention rate.

The present disclosure may provide an anodeless all-solid-state battery having a high energy density.

The present disclosure may provide an anodeless all-solid-state battery having a long lifespan.

The invention has been described in detail with reference to various exemplary embodiments thereof. However, it will be appreciated by those skilled in the art that changes may be made in these embodiments without departing from the principles and spirit of the invention, the scope of which is defined in the appended claims and their equivalents.

What is claimed is:

1. An all-solid-state battery comprising:
a composite membrane comprising a first surface and a second surface;
a first solid electrolyte layer disposed on the first surface of the composite membrane;
a first cathode active material layer disposed on the first solid electrolyte layer;
a first cathode current collector disposed on the first cathode active material layer;
a second solid electrolyte layer disposed on the second surface of the composite membrane;
a second cathode active material layer disposed on the second solid electrolyte layer; and
a second cathode current collector disposed on the second cathode active material layer, wherein:
the composite membrane comprises a conductive material;
the composite membrane comprises pores;
the composite membrane comprises a first layer configured to form the first main surface, a second layer configured to form the second surface, and an intermediate layer interposed between the first layer and the second layer; and
the first layer and the second layer each comprises metal powder configured to be alloyable with lithium.

2. The all-solid-state battery of claim 1, wherein the conductive material comprises a linear carbon material.

3. The all-solid-state battery of claim 2, wherein the linear carbon material comprises carbon nanofibers, carbon nanotubes, vapor-grown carbon fibers, or combinations thereof.

4. The all-solid-state battery of claim 2, wherein a length of the linear carbon material is about 0.01 m to 1 μm.

5. The all-solid-state battery of claim 2, wherein a diameter of the linear carbon material is about 1 nm to 200 nm.

6. The all-solid-state battery of claim 2, wherein:
the linear carbon material forms a net shape so that the composite membrane comprises pores; and
lithium is stored in the pores when the all-solid-state battery is charged.

7. The all-solid-state battery of claim 1, wherein porosity of the composite membrane is about 0.1% to 50%.

8. The all-solid-state battery of claim 1, wherein a thickness of the composite membrane is about 1 m to 200 μm.

9. The all-solid-state battery of claim 1, wherein:
a thickness of the first layer is about 10% to 40% of an overall thickness of the composite membrane;
a thickness of the second layer is about 10% to 40% of the overall thickness of the composite membrane; and
a thickness of the intermediate layer is about 20% to 80% of the overall thickness of the composite membrane.

10. The all-solid-state battery of claim 1, wherein the metal powder comprises one or more selected from the group consisting of aluminum (Al), zinc (Zn), indium (In), silver (Ag), gold (Au), magnesium (Mg), silicon (Si), bismuth (Bi), germanium (Ge), platinum (Pt), antimony (Sb), and tin (Sn).

11. The all-solid-state battery of claim 1, wherein a median particle diameter D50 of the metal powder is about 0.01 μm to 1 μm.

12. The all-solid-state battery of claim 1, wherein the first layer comprises:
an amount of about 50 wt % to 99 wt % of the porous conductive material;
an amount of about 0.1 wt % to 45 wt % of the metal powder; and
an amount of about 0.1 wt % to 10 wt % of a binder,
based on the total weight of the first layer.

13. The all-solid-state battery of claim 1, wherein the second layer comprises:
an amount of about 50 wt % to 99 wt % of the porous conductive material;
an amount of about 0.1 wt % to 45 wt % of the metal powder; and
an amount of about 0.1 wt % to 10 wt % of a binder,
based on the total weight of the second layer.

14. The all-solid-state battery of claim 1, wherein the intermediate layer comprises:
an amount of about 90 wt % to 99.9 wt % of the porous conductive material; and
an amount of about 0.1 wt % to 10 wt % of a binder,
based on the total weight of the intermediate layer.

15. A vehicle comprising an all-solid-state battery of claim 1.
